(19) United States
(12) Patent Application Publication
(10) Pub. No.: US 2026/0222917 A1
(43) Pub. Date: Jul. 30, 2026

(54) QOS MANAGEMENT METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Yanhua LI, Beijing (CN)

(21) Appl. No.: 19/141,367

(22) PCT Filed: Dec. 20, 2022
(86) PCT No.: PCT/CN2022/140505

§ 371 Date: Jun. 20, 2025

(51) Int. Cl. H04W 28/24

(52) U.S. Cl. CPC H04W 28/24

(57) ABSTRACT

A quality of service (QoS) management method is performed by a base station and includes: determining QoS management based on first information, wherein the first information includes a core network policy and/or QoS requirement information indicating a core network QoS requirement.

### CROSS-REFERENCE TO RELATED APPLICATION

The present application is a U.S. National Stage of International Application No. PCT/CN2022/140505, filed on Dec. 20, 2022, the content of which is incorporated herein by reference in its entirety.

### TECHNICAL FIELD

The present disclosure relates to, but is not limited to, the field of wireless communication technologies, and in particular to QoS management processing methods and apparatuses, communication devices and storage media.

### BACKGROUND

In related technologies, for each Protocol Data Unit (PDU) session, a base station attempts to establish at least one Data Radio Bearer (DRB) and associates Quality of Service (QoS) flow(s) within the PDU session to the established DRB. In addition, in a Radio Access Network (RAN), a Packet Data Convergence Protocol (PDCH) is associated with multiple Radio Link Control (RLC) entities in a manner of differentiated handling based on the importance of QoS flows.

However, at present, there is no solution for the base station to handle the QoS flow in the PDU session to meet the QoS requirements of the core network.

### SUMMARY

According to a first aspect of an embodiment of the present disclosure, a QoS management method is provided, which is performed by a base station and includes:
determining QoS management based on first information, where the first information includes a core network policy and/or QoS requirement information indicating a core network QoS requirement.

In some embodiments, the first information indicates at least one of:
whether in-sequence delivery of services is required; or
whether differentiated handling for a QoS flow is required.

In some embodiments, the determining QoS management based on first information includes one of:
determining, based on the first information, to map a plurality of QoS flows to one or more data radio bearers (DRBs); or
determining, based on the first information, to map one QoS flow to one or more logical channels associated with one DRB.

In some embodiments, the determining, based on the first information, to map a plurality of QoS flows to one or more DRBs includes one of:
mapping the plurality of QoS flows to one of the one or more DRBs based on the core network policy indicating that in-sequence delivery of services is required; or
mapping the plurality of QoS flows to the one or more DRBs based on the core network policy indicating that in-sequence delivery of services is not required.

In some embodiments, the method includes:
receiving a protocol data unit (PDU) session sent by a core network device, where the PDU session carries first indication information, and the first indication information indicates whether in-sequence delivery of services is required.

In some embodiments, the method includes:
determining, based on an absence of the first indication information in the PDU session, that in-sequence delivery of services is not required.

In some embodiments, the determining, based on the first information, to map one QoS flow to one or more logical channels associated with one DRB includes one of:
determining, based on the core network policy indicating that differentiated handling for data packets and/or data packet sets within one QoS flow is required, to map data packets and/or data packet sets within the one QoS flow to one or more logical channels associated with one DRB, where a data packet set includes one or more data packets; or
determining, based on the core network policy indicating that differentiated handling for data packets and/or data packet sets within one QoS flow is not required, to map the data packets and/or data packet sets within the one QoS flow to one logical channel associated with one DRB.

In some embodiments, the method includes:
receiving a QoS flow sent by a core network device, where the QoS flow carries second indication information, and the second indication information indicates whether differentiated handling for the QoS flow is required.

In some embodiments, the method includes:
determining, based on an absence of the second indication information in the QoS flow, that differentiated handling for the QoS flow is not required.

In some embodiments, the method includes:
receiving QoS requirement information sent by a core network device, where the QoS requirement information includes at least one of:
a PDU set importance level; or
a QoS parameter set according to the PDU set importance level, where the QoS parameter includes at least one of: a PDU set error rate (PSER), a PDU set delay budget (PSDB), or a PDU set integrated indication (PSII).

In some embodiments, the determining QoS management based on first information includes one of:
mapping PDU sets corresponding to different PDU set importance levels within a QoS flow to one logical channel associated with one data radio bearer (DRB); or
mapping PDU sets corresponding to different PDU set importance levels within a QoS flow to identical one or different multiple logical channels associated with one DRB.

In some embodiments, the method includes one of:
determining, based on the first information indicating that in-sequence delivery of services is required and the base station being capable of mapping a plurality of QoS flows to one DRB for in-sequence delivery of services, that a PDU session establishment is successful;
determining, based on the first information indicating that in-sequence delivery of services is required and the base station being unable to map a plurality of QoS flows to one DRB for in-sequence delivery of services, that a PDU session establishment fails; or
mapping, based on the first information indicating that in-sequence delivery of services is required and the base station being unable to map a plurality of QoS flows to one DRB for in-sequence delivery of services, the plurality of QoS flows to one or more DRBs and determining that a PDU session establishment is successful.

In some embodiments, the method includes:
sending first response information to a core network device, where the first response information includes at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

In some embodiments, the method includes one of:
determining, based on the first information indicating that differentiated handling for a QoS flow is required and the base station being capable of mapping the QoS flow to one or more logical channels associated with one DRB, that a QoS flow establishment is successful;
determining, based on the first information indicating that differentiated handling for a QoS flow is required and the base station being unable to map the QoS flow to a plurality of logical channels associated with one DRB, that a QoS flow establishment fails;
determining, based on the first information indicating that differentiated handling for a QoS flow is required and the base station being unable to map the QoS flow to at least one of a plurality of logical channels associated with one DRB, that a QoS flow establishment fails; or
mapping, based on the first information indicating that differentiated handling for a QoS flow is required and the base station being unable to map the QoS flow to a plurality of logical channels associated with one DRB, the QoS flow to at least one logical channel associated with the one DRB and determining that a QoS flow establishment is successful.

In some embodiments, the method includes:
sending second response information to a core network device, where the second response information includes at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

In some embodiments, the base station is a first base station, and the method includes:
sending handover request information to a second base station, where the handover request information requests a handover from the first base station to the second base station, and the handover request information includes the first information.

In some embodiments, the method includes:
receiving handover response information sent by the second base station, where the handover response information at least includes at least one of:
information indicating that the second base station is unable to provide a plurality of logical channels associated with one DRB; or
a reason why the second base station is unable to map a QoS flow to a plurality of logical channels for differentiated handling.

According to a second aspect of an embodiment of the present disclosure, a QoS management method is provided, which is performed by a core network device and includes:
sending second information to a base station, where the second information is used for the base station to determine a core network policy and/or the second information includes QoS requirement information indicating a core network QoS requirement, and the second information is used for the base station to determine QoS management.

In some embodiments, the second information includes first indication information, and the sending second information to a base station includes:
sending a protocol data unit (PDU) session to the base station, where the PDU session carries the first indication information, and the first indication information indicates whether in-sequence delivery of services is required.

In some embodiments, the second information includes second indication information; and the sending second information to a base station includes:
sending a QoS flow to the base station, where the QoS flow carries second indication information, and the second indication information indicates whether differentiated handling for the QoS flow is required.

In some embodiments, the second information includes QoS requirement information, where the QoS requirement information includes at least one of:
a PDU set importance level; or
a QoS parameter set according to the PDU set importance level, where the QoS parameter includes at least one of: a PDU set error rate (PSER), a PDU set delay budget (PSDB), or a PDU set integrated indication (PSII).

In some embodiments, the QoS requirement information is used for the base station to map one QoS flow to one or more logical channels associated with one DRB.

In some embodiments, the method includes:
receiving first response information sent by the base station, where the first response information includes at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

In some embodiments, the method includes:
receiving second response information sent by the base station, where the second response information includes at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

According to a third aspect of an embodiment of the present disclosure, a QoS management apparatus is provided, including:
a first processing module, configured to determine QoS management based on first information, where the first information includes a core network policy and/or QoS requirement information indicating a core network QoS requirement.

In some embodiments, the first information indicates at least one of:
whether in-sequence delivery of services is required; or
whether differentiated handling for a QoS flow is required.

In some embodiments, the first processing module, is configured to determine, based on the first information, to map a plurality of QoS flows to one or more DRBs; or

the first processing module, is configured to determine, based on the first information, to map one QoS flow to one or more logical channels associated with one DRB.

In some embodiments, the first processing module is configured to map the plurality of QoS flows to one of the one or more DRBs based on the core network policy indicating that in-sequence delivery of services is required; or
the first processing module is configured to map the plurality of QoS flows to the one or more DRBs based on the core network policy indicating that in-sequence delivery of services is not required.

In some embodiments, the apparatus includes: a first receiving module configured to receive a protocol data unit (PDU) session sent by a core network device, where the PDU session carries first indication information, and the first indication information indicates whether in-sequence delivery of services is required.

In some embodiments, the first processing module is configured to determine, based on an absence of the first indication information in the PDU session, that in-sequence delivery of services is not required.

In some embodiments, the first processing module is configured to determine, based on the core network policy indicating that differentiated handling for data packets and/or data packet sets within one QoS flow is required, to map the data packets and/or data packet sets within the one QoS flow to one or more logical channels associated with one DRB, where a data packet set includes one or more data packets; or
the first processing module is configured to determine, based on the core network policy indicating that differentiated handling for data packets and/or data packet sets within one QoS flow is not required, to map the data packets and/or data packet sets within the one QoS flow to one logical channel associated with one DRB.

In some embodiments, the first receiving module is configured to receive a QoS flow sent by a core network device, where the QoS flow carries second indication information, and the second indication information indicates whether differentiated handling for the QoS flow is required.

In some embodiments, the first processing module is configured to determine, based on an absence of the second indication information in the QoS flow, that differentiated handling for the QoS flow is not required.

In some embodiments, the first receiving module is configured to receive QoS requirement information sent by a core network device, where the QoS requirement information includes at least one of:
a PDU set importance level; or
a QoS parameter set according to the PDU set importance level, where the QoS parameter includes at least one of: a PDU set error rate (PSER), a PDU set delay budget (PSDB), or a PDU set integrated indication (PSII).

In some embodiments, the first processing module is configured to map PDU sets corresponding to different PDU set importance levels within a QoS flow to one logical channel associated with one data radio bearer (DRB); or
the first processing module is configured to map PDU sets corresponding to different PDU set importance levels within a QoS flow to identical one or different multiple logical channels associated with one DRB.

In some embodiments, the first processing module is configured to perform one of:
determining, based on the first information indicating that in-sequence delivery of services is required and the base station being capable of mapping a plurality of QoS flows to one DRB for in-sequence delivery of services, that a PDU session establishment is successful;
determining, based on the first information indicating that in-sequence delivery of services is required and the base station being unable to map a plurality of QoS flows to one DRB for in-sequence delivery of services, that a PDU session establishment fails; or
mapping, based on the first information indicating that in-sequence delivery of services is required and the base station being unable to map a plurality of QoS flows to one DRB for in-sequence delivery of services, the plurality of QoS flows to one or more DRBs and determining that a PDU session establishment is successful.

In some embodiments, the apparatus includes a first sending module configured to send first response information to a core network device, where the first response information includes at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

In some embodiments, the first processing module is configured to perform one of:
determining, based on the first information indicating that differentiated handling for a QoS flow is required and the base station being capable of mapping the QoS flow to one or more logical channels associated with one DRB, that a QoS flow establishment is successful;
determining, based on the first information indicating that differentiated handling for a QoS flow is required and the base station being unable to map the QoS flow to a plurality of logical channels associated with one DRB, that a QoS flow establishment fails;
determining, based on the first information indicating that differentiated handling for a QoS flow is required and the base station being unable to map the QoS flow to at least one of a plurality of logical channels associated with one DRB, that a QoS flow establishment fails; or
mapping, based on the first information indicating that differentiated handling for a QoS flow is required and the base station being unable to map the QoS flow to a plurality of logical channels associated with one DRB, the QoS flow to at least one logical channel associated with the one DRB and determining that a QoS flow establishment is successful.

In some embodiments, the first sending module is configured to send second response information to a core network device, where the second response information includes at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

In some embodiments, the base station is a first base station, and the first sending module is configured to send handover request information to a second base station, where the handover request information requests a handover from the first base station to the second base station, and the handover request information includes the first information.

In some embodiments, the first receiving module is configured to receive handover response information sent by the second base station, where the handover response information at least includes at least one of:
information indicating that the second base station is unable to provide a plurality of logical channels associated with one DRB; or
a reason why the second base station is unable to map a QoS flow to a plurality of logical channels for differentiated handling.

According to a fourth aspect of an embodiment of the present disclosure, a QoS management apparatus is provided, including:
a second sending module, configured to send second information to a base station, where the second information is used for the base station to determine a core network policy and/or the second information includes QoS requirement information indicating a core network QoS requirement, and the second information is used for the base station to determine QoS management.

In some embodiments, the second information includes the first indication information;
the second sending module configured to send a protocol data unit (PDU) session to the base station, where the PDU session carries the first indication information, and the first indication information indicates whether in-sequence delivery of services is required.

In some embodiments, the second information includes second indication information;
the second sending module configured to send a QoS flow to the base station, where the QoS flow carries second indication information, and the second indication information indicates whether differentiated handling for the QoS flow is required.

In some embodiments, the second information includes QoS requirement information, where the QoS requirement information includes at least one of:
a PDU set importance level; or
a QoS parameter set according to the PDU set importance level, where the QoS parameter includes at least one of: a PDU set error rate (PSER), a PDU set delay budget (PSDB), or a PDU set integrated indication (PSII).

In some embodiments, the QoS requirement information is used for the base station to map one QoS flow to one or more logical channels associated with one DRB.

In some embodiments, the apparatus includes a second receiving module, the second receiving module is configured to receive first response information sent by the base station, where the first response information includes at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

In some embodiments, the second receiving module is configured to receive second response information sent by the base station, where the second response information includes at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

According to a fifth aspect of the present disclosure, a communication device is provided, including:
a processor; and
a memory, configured to store processor-executable instructions;
where the processor is configured to implement the QoS management method of any embodiment of the present disclosure when executing the executable instructions.

According to a sixth aspect of the present disclosure, a computer storage medium is provided, where the computer storage medium stores a computer executable program, and the executable program, when executed by a processor, realizes the QoS management method described in any embodiment of the present disclosure.

The technical solutions provided by the embodiments of the present disclosure can include the following beneficial effects:

In the embodiment of the present disclosure, the base station determines QoS management based on first information, where the first information includes a core network policy and/or QoS requirement information indicating a core network QoS requirement. In this way, in the embodiment of the present disclosure, the base station can use the core network policy and/or the QoS requirement information to split the QoS flow(s) to meet the QoS requirement of the core network.

It should be understood that the above general description and the following detailed descriptions are exemplary and explanatory only and do not limit the embodiments of the present disclosure.

### BRIEF DESCRIPTION OF DRAWINGS

FIG. 1 is a schematic structural diagram of a wireless communication system according to an embodiment of the present disclosure.

FIG. 2 is a PDU session resource processing method according to an embodiment of the present disclosure.

FIG. 3 is a schematic diagram of a QoS management method according to an embodiment of the present disclosure.

FIG. 4 is a schematic diagram of a QoS management method according to an embodiment of the present disclosure.

FIG. 5 is a schematic diagram of a QoS management method according to an embodiment of the present disclosure.

FIG. 6 is a schematic diagram of a QoS management method according to an embodiment of the present disclosure.

FIG. 7 is a schematic diagram of a QoS management method according to an embodiment of the present disclosure.

FIG. 8 is a schematic diagram of a QoS management method according to an embodiment of the present disclosure.

FIG. 9 is a schematic diagram of a QoS management apparatus according to an embodiment of the present disclosure.

FIG. 10 is a schematic diagram of a QoS management apparatus according to an embodiment of the present disclosure.

FIG. 11 is a block diagram of a UE according to an embodiment of the present disclosure.

FIG. 12 is a block diagram of a base station according to an embodiment of the present disclosure.

### DETAILED DESCRIPTION

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiment of the present disclosure do not represent all implementations consistent with the embodiments of the present disclosure. Rather, they are merely examples of apparatuses and methods consistent with some aspects of embodiments of the present disclosure as detailed in the appended claims.

Terms used in embodiments of the present disclosure are only for a purpose of describing specific embodiments, and are not limiting the embodiments of the present disclosure. Singular forms of “a”, said”, and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, these information should not be limited to these terms. These terms are used only to distinguish the same type of information from one another. For example, without departing from the scope of the present disclosure, first information can also be named as second information, and similarly, the second information can also be named as the first information. Depending on the context, the word “if” as used herein can be interpreted as “at” or “when” or “in response to determining”.

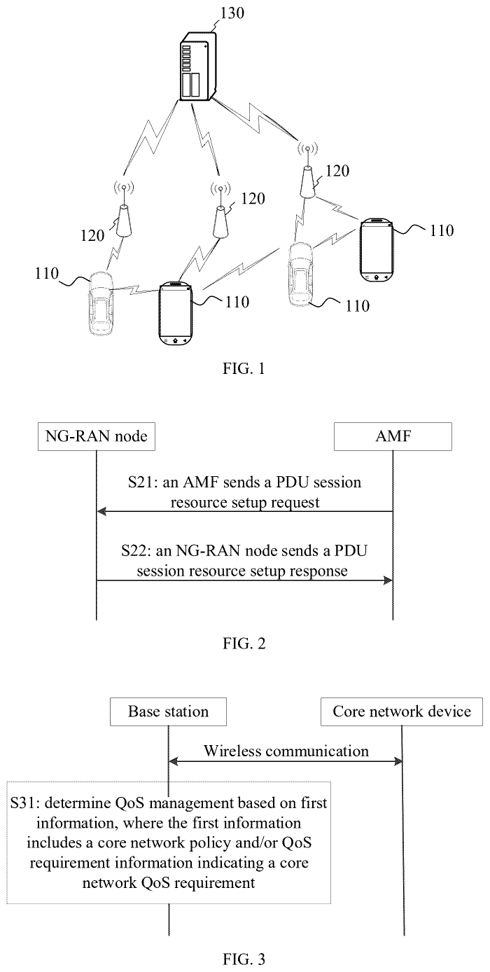

Please refer to FIG. 1, which shows a schematic structural diagram of a wireless communication system according to an embodiment of the present disclosure. As shown in FIG. 1, the wireless communication system is a communication system based on cellular mobile communication technology, which may include several user equipments 110 and several base stations 120.

A user equipment 110 may be a device that provides voice and/or data connectivity to users. The user equipment 110 can communicate with one or more core networks via a radio access network (RAN). The user equipment 110 can be an Internet of Things user equipment, such as a sensor device, a mobile phone (or a “cellular” phone) and a computer with an Internet of Things user equipment. For example, it can be a fixed, portable, pocket-sized, handheld, computer-built or vehicle-mounted device. For example, a station (STA), a subscriber unit, a subscriber station, a mobile station, a mobile, a remote station, an access point, a remote terminal, an access terminal, a user terminal, a user agent, a user device, or a user equipment. Or, the user equipment 110 can also be a device for an unmanned aerial vehicle. Or, the user equipment 110 can also be a vehicle-mounted device, for example, a driving computer with wireless communication function or a wireless user equipment with an external driving computer. Or, the user equipment 110 can also be a roadside device, such as a street lamp, a signal lamp or other roadside device with wireless communication function.

The base station 120 may be a network-side device in a wireless communication system. The wireless communication system can be the 4th generation mobile communication (4G) system, also known as long term evolution (LTE) system. Or, the wireless communication system can also be a 5G system, also known as a new radio (NR) system or a 5G NR system. Or, the wireless communication system can also be a further next-generation system of a 5G system. An access network in the 5G system can be named as a new generation-radio access network (NG-RAN).

The base station 120 may be an evolved Node B (eNB) adopted in the 4G system. Or, the base station 120 can also be a next generation Node B (gNB) adopting a centralized and distributed architecture in the 5G system. When the base station 120 adopts a centralized and distributed architecture, it usually includes a central unit (CU) and at least two distributed units (DUs). The centralized unit is provided with a protocol stack of a packet data convergence protocol (PDCP) layer, a radio link Control Protocol (RLC) layer and a medium access control (MAC) layer, a distributed unit is provided with a protocol stack of a physical (PHY) layer, and the embodiments of the present disclosure do not limit specific implementations of the base station 120.

A wireless connection can be established between the base station 120 and the user equipment 110 through a wireless air interface. In different implementations, the wireless radio is a wireless radio based on the fourth generation mobile communication network technology (4G) standard; or the wireless radio is a wireless radio based on the fifth generation mobile communication network technology (5G) standard, for example, the wireless radio is a new radio; or, the wireless radio can also be a wireless radio based on a more next generation mobile communication network technology standard based on 5G.

In some embodiments, an end to end (E2E) connection can further be established between the user equipments 110. For example, scenarios of vehicle to vehicle (V2V) communication, vehicle to infrastructure (V2I) communication and vehicle to pedestrian (V2P) communication in vehicle to everything (V2X) communication.

Here, the above-mentioned user equipment can be considered as a terminal device of the following embodiments.

In some embodiments, the wireless communication system may further include a network management device 130.

Several base stations 120 are respectively connected to a network management device 130. The network management device 130 may be a core network device in a wireless communication system. For example, the network management device 130 may be a mobility management entity (MME) in an evolved packet core (EPC). Or, the network management device can also be other core network devices, such as a Serving Gateway (SGW), a Public Data Network Gateway (PGW), a Policy and Charging Rules Function (PCRF), or a Home Subscriber Server (HSS), etc.; or, the core network device may be a core network device in a 5G network; for example, it could be an Access and Mobility Management Function (AMF), a Policy Control Function (PCF), or a Session Management Function (SMF), etc. Embodiments of the present disclosure do not limit the implementation form of the network management device 130.

In order to facilitate the understanding of those skilled in the art, the embodiments of the present disclosure list a plurality of implementations to clearly explain the technical solution of the embodiments of the present disclosure. Of course, those skilled in the art can understand that the multiple embodiments provided in the present disclosure can be executed separately, combined with the methods of other embodiments in the present disclosure, or executed separately or in combination with some methods in other related technologies. Embodiment of that present disclosure do not limit this.

It is to be noted that when a plurality of executing subjects are involved in the embodiments of the present disclosure, when an executing subject sends a certain transmission to another executing subject, it may mean that the executing subject sends the transmission directly to another executing subject, or it may mean that the executing subject sends the transmission to another executing subject through other arbitrary devices; this is not limited in the embodiments of the present disclosure.

In order to better understand the technical solutions described in any of the embodiments of the present disclosure, first, some related technologies are explained.

In an embodiment, as shown in FIG. 2, a Protocol Data Unit (PDU) session resource processing method is provided; the method includes: step S21: an AMF sends a PDU session resource setup request; and step S22: an NG-RAN node sends a PDU session resource setup response.

Here, for each PDU session, the base station attempts to establish at least one Data Radio Bearer (DRB) and associate a Quality of Service (QoS) flow in the PDU session with the established DRB. For example, one QoS flow can be carried on one DRB, or multiple QoS flows can be carried on one DRB.

In the communication standard, it can be expressed as: For each requested PDU session, if resources are available for the requested configuration, the NG-RAN node shall establish at least one DRB and associate each accepted QoS flow of the PDU session to a DRB established.

Successful establishment of PDU session information will be carried in a response message to a core network, which may include partially failed QoS flow and/or failed PDU session information.

The NG-RAN node shall report, in a PDU session resource setup response message to the AMF, the result for each PDU session resource requested to be setup:

For each PDU session resource successfully setup, an PDU Session Resource Setup Response Information Element (IE) shall include the following.
(1) NG user-plane interface (NG-U) user-plane (UP) transport layer information used for the PDU session and an associated list of QoS flows that have been successfully setup, in QoS flows for each Transport Network layer (TNL) information IE.
(2) The list of QoS flows which failed to be setup, if any, in the QoS Flow Failed to Setup List IE. When the NG-RAN node reports that the setup of QoS flow is unsuccessful, a cause value should be precise enough to enable an SMF can know the reason for the unsuccessful establishment.

In the communication standard, it can be expressed as:
(1) The NG-U UP transport layer information to be used for the PDU session and associated list of QoS flows which have been successfully established, in the QoS Flow per TNL Information IE.
(2) The list of QoS flows which failed to be established, if any, in the QoS Flow Failed to Setup List IE. When the NG-RAN node reports unsuccessful establishment of a QoS flow, the cause value should be precise enough to enable the SMF to know the reason for the unsuccessful establishment.

In another embodiment, in Extended Reality (XR) services, multi-stream transmission and the concept of multi-stream modeling are introduced. This involves differentiating data based on its importance, such as modeling I-frames and P-frames, where I-frames can be considered relatively more important. Therefore, different transmission QoS requirements need to be adopted considering the varying importance of data packets and/or sets of data packets within the data flow. On the Radio Access Network (RAN) side, data packets and/or sets of data packets are differentiated based on their importance, and the Packet Data Convergence Protocol (PDCP) is associated with multiple Radio Link Control (RLC) entities or with multiple logical channels within a DRB.

An embodiment of the present disclosure provides a QoS management method, which is performed by a base station and includes: determining QoS management based on first information.

As shown in FIG. 3, an embodiment of the present disclosure provides a QoS management method, which is performed by a base station and includes the following step.

Step S31: determining QoS management based on first information, where the first information includes a core network policy and/or QoS requirement information indicating a core network QoS requirement.

The QoS management method provided by the embodiments of the present disclosure may also be performed by an access network device. The access network device may be, but is not limited to, a base station. The base station may be various types of base stations, such as may be, but is not limited to, at least one of: a 3G base station, a 4G base station, a 5G base station, and other evolved base stations. Or, the access network device may be a logical node or a function or an entity implementing a function, etc., flexibly arranged in the access network.

In an embodiment, the first information indicates, but not limited to, whether in-sequence delivery of services is required; and/or whether differentiated handling for a QoS flow is required.

In an embodiment, the core network policy is used to determine any policy for mapping a plurality of QoS flows to one or more DRBs and/or any policy for indicating that one QoS flow is mapped to one or more logical channels associated with one DRB. In the embodiments of the present disclosure, a plurality may be two or more than two.

In an embodiment, a QoS flow includes at least one data packet and/or at least one data packet set, and a data packet set includes at least one data packet. Here, the data packet may be a PDU, the data packet may be a PDU set, and a PDU set includes at least one PDU. In the embodiments of the present disclosure, at least one may be one or more than one.

In an embodiment, the core network policy indicates whether in-sequence delivery of services is required. For example, the core network policy indicates whether in-sequence delivery of services is required. For example, the core network policy indicates whether in-sequence delivery of services by an Access Stratum (AS) is required. For example, the core network policy indicates whether in-sequence delivery of services by an application layer is required. Here, whether in-sequence delivery of services is required includes: in-sequence delivery of services is required, or in-sequence delivery of services is not required.

In another embodiment, the core network policy indicates whether differentiated handling for a QoS flow is required. For example, the core network policy indicates that differentiated handling for a QoS flow by the AS is required. For example, the core network policy indicates that differentiated handling for data packets and/or data packet sets of a QoS flow by the AS is required. Here, whether differentiated handling for a QoS flow is required includes: differentiated handling for a QoS flow is required, or differentiated handling for a QoS flow is not required.

In an embodiment, the QoS requirement information includes but is not limited to at least one of:
a PDU set importance level; or
a QoS parameter, where the QoS parameter includes at least one of: a PDU set error rate (PSER), a PDU set delay budget (PSDB), or a PDU set integrated indication (PSII).

Here, the PSII indicates whether the application layer requires all PDUs when using a PDU set.

Here, the QoS parameter is for each PDU set importance level. For example, a QoS flow includes at least one PDU set importance level, and each PDU set importance level is associated with a set of QoS parameters.

An embodiment of the present disclosure provides a QoS management method, which is performed by a base station and includes: determining QoS management based on a core network policy.

An embodiment of the present disclosure provides a QoS management method, which is performed by a base station and includes: determining QoS management based on a QoS parameter.

In an embodiment, the QoS management includes but is not limited to at least one of:
mapping one QoS flow to one DRB;
mapping a plurality of QoS flows to one DRB;
mapping at least one QoS flow among a plurality of QoS flows to one DRB;
mapping one QoS flow to one logical channel associated with one DRB; or
mapping one QoS flow to a plurality of logical channels associated with one DRB.

In the embodiment of the present disclosure, the base station determines QoS management based on the first information, where the first information includes a core network policy and/or QoS requirement information indicating a core network QoS requirement. In this way, in the embodiment of the present disclosure, the base station can use the core network policy and/or the QoS requirement information to split the QoS flow(s) to meet the QoS requirement of the core network.

It should be noted that those skilled in the art can understand that the methods provided by the embodiments of the present disclosure can be executed alone or together with some methods in the embodiments of the present disclosure or some methods in related technologies.

An embodiment of the present disclosure provides a QoS management method, which is performed by a base station and includes: determining, based on a core network policy, to map QoS flow(s) to DRB(s); or, determining, based on the core network policy, to map QoS flow(s) to logical channel(s) of DRB(s). Here, the determining to map QoS flow(s) to DRB(s) includes: determining to map a plurality of QoS flows to one DRB or a plurality of DRBs. The mapping a plurality of QoS flows to a plurality of DRBs includes: mapping one QoS flow to one DRB. Here, the determining to map QoS flow(s) to logical channel(s) of DRB(s) includes: mapping a QoS flow to a logical channel or a plurality of logical channels associated with one DRB.

In some embodiments, in step S31, determining QoS management based on first information includes one of:
determining, based on the first information, to map a plurality of QoS flows to one or more DRBs; or
determining, based on the first information, to map one QoS flow to one or more logical channels associated with one DRB.

In some embodiments, in step S31, determining QoS management based on first information includes one of:
determining, based on the core network policy, to map a plurality of QoS flows to one or more DRBs; or
determining, based on the core network policy, to map one QoS flow to one or more logical channels associated with one DRB.

As shown in FIG. 4, an embodiment of the present disclosure provides a QoS management method, which is performed by a base station and includes the following step.

Step S41: determining, based on the first information, to map a plurality of QoS flows to one or more DRBs; or determining, based on the first information, to map one QoS flow to one or more logical channels associated with one DRB.

In some embodiments, in step S41, the determining, based on the first information, to map a plurality of QoS flows to one or more DRBs includes one of:
mapping the plurality of QoS flows to one of the one or more DRBs based on the first information indicating that in-sequence delivery of services is required; or
mapping the plurality of QoS flows to the one or more DRBs based on the first information indicating that in-sequence delivery of services is not required.

Here, mapping the plurality of QoS flows to one of the one or more DRBs based on the first information indicating that in-sequence delivery of services is required, which may be: mapping the plurality of QoS flows to one of the one or more DRBs based on the core network policy indicating that in-sequence delivery of services is required. And/or, mapping the plurality of QoS flows to the one or more DRBs based on the first information indicating that in-sequence delivery of services is not required, which may be: mapping the plurality of QoS flows to the one or more DRBs based on the core network policy indicating that in-sequence delivery of services is not required.

An embodiment of the present disclosure provides a QoS management method, which is performed by a base station and includes one of:
mapping a plurality of QoS flows to one DRB based on a core network policy indicating that in-sequence delivery of services is required; or
mapping a plurality of QoS flows to one or more DRBs based on a core network policy indicating that in-sequence delivery of services is not required.

An embodiment of the present disclosure provides a QoS management method, which is performed by a base station and includes: receiving a protocol data unit (PDU) session sent by a core network device, where the PDU session carries first indication information, and the first indication information indicates whether in-sequence delivery of services is required.

In the embodiments of the present disclosure, a core network device may be, but is not limited to, a logical node or a function or an entity that implements a function, etc., flexibly arranged in a core network. For example, a core network device may be, but is not limited to, an AMF.

For example, the first indication information takes a first value to indicate that in-sequence delivery of services by an AS is required; or, the first indication information takes a second value to indicate that in-sequence delivery of services is not required.

For example, the base station receives PDU session(s) sent by the core network device, where a PDU session carries the first indication information. If the base station determines that the first indication information indicates that in-sequence delivery of services by the AS is required, it determines to map a plurality of QoS flows to a DRB; or, if the base station determines that the first indication information indicates that in-sequence delivery of services by the AS is not required, it determines to map a plurality of QoS flows to one DRB or a plurality of DRBs. Here, the mapping a plurality of QoS flows to a plurality of DRBs may be: mapping each QoS flow to one DRB respectively.

In the embodiment of the present disclosure, if the base station determines that the core network policy indicates that in-sequence delivery of services by the AS is required, a plurality of QoS flows can be mapped to one DRB, thus enabling in-sequence delivery of QoS flows. Or, if the base station determines that the core network policy indicates that in-sequence delivery of services by the AS is not required, it can perform QoS flow delivery by mapping a plurality of QoS flows to one or more DRBs based on relevant technologies.

Of course, in other embodiments, the core network policy may also indicate whether in-sequence delivery of services by an application layer is required. Here, when the AS cannot determine whether in-sequence delivery of services is required, it may be determined by the application layer.

An embodiment of the present disclosure provides a QoS management method, which is performed by a base station and includes: determining a core network policy based on the first indication information. For example, the base station determines, based on the first indication information indicating that in-sequence delivery of services by the AS is required, the core network policy to indicate that in-sequence delivery of services by the AS is required; or, determines, based on the first indication information indicating that in-sequence delivery of services by the AS is not required, the core network policy to indicate that in-sequence delivery of services by the AS is not required. In this way, the base station can accurately determine the core network policy based on the first indication information carried in the PDU session.

An embodiment of the present disclosure provides a QoS management method, which is performed by a base station and includes: determining, based on an absence of the first indication information in the PDU session, that in-sequence delivery of services is not required.

An embodiment of the present disclosure provides a QoS management method, which is performed by a base station and includes: determining, based on an absence of information indicating whether in-sequence delivery of services is required in the core network policy, that in-sequence delivery of services is not required.

In the embodiment of the present disclosure, information (e.g., first indication information) indicating whether in-sequence delivery of services is required is optionally carried in the core network policy or PDU session, and if the first indication information is not carried in the core network policy or PDU session, it is determined that in-sequence delivery of services by the AS is not required. In this way, it can accurately determine that in-sequence delivery of services is not required, and then accurately determine the way of QoS management.

It should be noted that those skilled in the art can understand that the methods provided by the embodiments of the present disclosure can be executed alone or together with some methods in the embodiments of the present disclosure or some methods in related technologies.

In some embodiments, step S41 includes one of:
determining, based on the core network policy indicating that differentiated handling for data packets and/or data packet sets within one QoS flow is required, to map the data packets and/or data packet sets within the one QoS flow to a plurality of logical channels associated with one DRB, where a data packet set includes one or more data packets; or
determining, based on the core network policy indicating that differentiated handling for data packets and/or data packet sets within one QoS flow is not required, to map the data packets and/or data packet sets within the one QoS flow to one logical channel associated with one DRB.

An embodiment of the present disclosure provides a QoS management method, which is performed by a base station and includes one of:
determining, based on the core network policy indicating that differentiated handling for a QoS flow is required, to map one QoS flow to one or more logical channels associated with one DRB; or
determining, based on the core network policy indicating that differentiated handling for a QoS flow is not required, to map one QoS flow to one logical channel associated with one DRB.

An embodiment of the present disclosure provides a QoS management method, which is performed by a base station and includes one of:
determining, based on the core network policy indicating that differentiated handling for data packets and/or data packet sets within one QoS flow is required, to map the data packets and/or data packet sets within the one QoS flow to one or more logical channels associated with one DRB, where a data packet set includes one or more data packets; or
determining, based on the core network policy indicating that differentiated handling for data packets and/or data packet sets within one QoS flow is not required, to map the data packets and/or data packet sets within the one QoS flow to one logical channel associated with one DRB.

Here, the mapping one QoS flow to one or more logical channels associated with one DRB includes: mapping data packets and/or data packet sets of the one QoS flow to of the one or more logical channels associated with the one DRB.

Here, the mapping one QoS flow to one logical channel associated with one DRB includes: mapping data packets and/or data packet sets of the one QoS flow to the one logical channel associated with the one DRB.

An embodiment of the present disclosure provides a QoS management method, which is performed by a base station and includes: receiving a QoS flow sent by a core network device, where the QoS flow carries second indication information, and the second indication information indicates whether differentiated handling for the QoS flow is required.

For example, when the second indication information takes a third value, it indicates that differentiated handling for a QoS flow by the AS is required. Or, when the second indication information takes a fourth value, it indicates that differentiated handling for a QoS flow by the AS is not required.

Both the first indication information in the above embodiments and the second indication information related to the embodiments of the present disclosure may be one or more bits. For example, when the first indication information takes a first value, it could be that the first indication information is “0” or “00”, etc. When the first indication information takes a second value, it could be that the first indication information is “1” or “01”, etc. Similarly, when the second indication information takes a third value, it could be that the second indication information is “0” or “00”. When the second indication information takes a fourth value, it could be that the second indication information is “1” or “11”, etc.

For example, the base station receives a QoS flow sent by a core network device, where the QoS flow carries a second indication information. If the base station determines that the second indication information indicates that differentiated handling for data packets and/or data packet sets of a QoS flow is required, it determines to map the QoS flow to one DRB and associate the one DRB with one or more logical channels. Or, if the base station determines that the second indication information indicates that differentiated handling for data packets and/or data packet sets of a QoS flow is not required, it determines to map the QoS flow to one DRB and associate the one DRB with one logical channel.

In the embodiment of the present disclosure, the base station may map one QoS to a plurality of logical channels or one logical channel associated with one DRB according to the core network policy or the indication information carried in the QoS flow indicating whether differentiated handling for data packets and/or data packet sets within the one QoS flow is required. This enables accurate implementation of split transmission based on whether differentiated handling for data packets and/or data packet sets within a QoS flow is required.

An embodiment of the present disclosure provides a QoS management method, which is performed by a base station and includes: determining a core network policy based on the second indication information. For example, if the second indication information indicates that differentiated handling for data packets and/or data packet sets within one QoS flow by the AS is required, the base station determines that the core network policy indicates that differentiated handling for data packets and/or data packet sets within one QoS flow by the AS is required. Or, if the second indication information indicates that differentiated for handling data packets and/or data packet sets within one QoS flow by the AS is not required, the base station determines that the core network policy indicates that differentiated handling for data packets and/or data packet sets within one QoS flow by the AS is not required. In this way, the base station can accurately determine the core network policy based on the second indication information carried within the QoS flow.

An embodiment of the present disclosure provides a QoS management method, which is performed by a base station and includes: determining, based on an absence of the second indication information in the QoS flow, that differentiated handling for the QoS flow is not required.

An embodiment of the present disclosure provides a QoS management method, which is performed by a base station and includes: determining, based on an absence of second indication information indicating whether differentiated handling for data packets and/or data packet sets within one QoS flow is required in the core network policy, that differentiated handling for data packets and/or data packet sets within one QoS flow is not required.

In the embodiment of the present disclosure, the information (e.g., second indication information) indicating whether differentiated handling for data packets and/or data packet sets within one QoS flow is required is optionally carried within the core network policy or the QoS flow. If the core network policy or the QoS flow does not carry the second indication information, it is determined that differentiated handling for the data packets and/or the data packet sets within the one QoS flow is not required. In this way, it can be accurately determined that differentiated handling for the data packets and/or data packet sets within the one QoS flow is not required, and then the QoS management method can be accurately determined.

It should be noted that those skilled in the art can understand that the methods provided by the embodiments of the present disclosure can be executed alone or together with some methods in the embodiments of the present disclosure or some methods in related technologies.

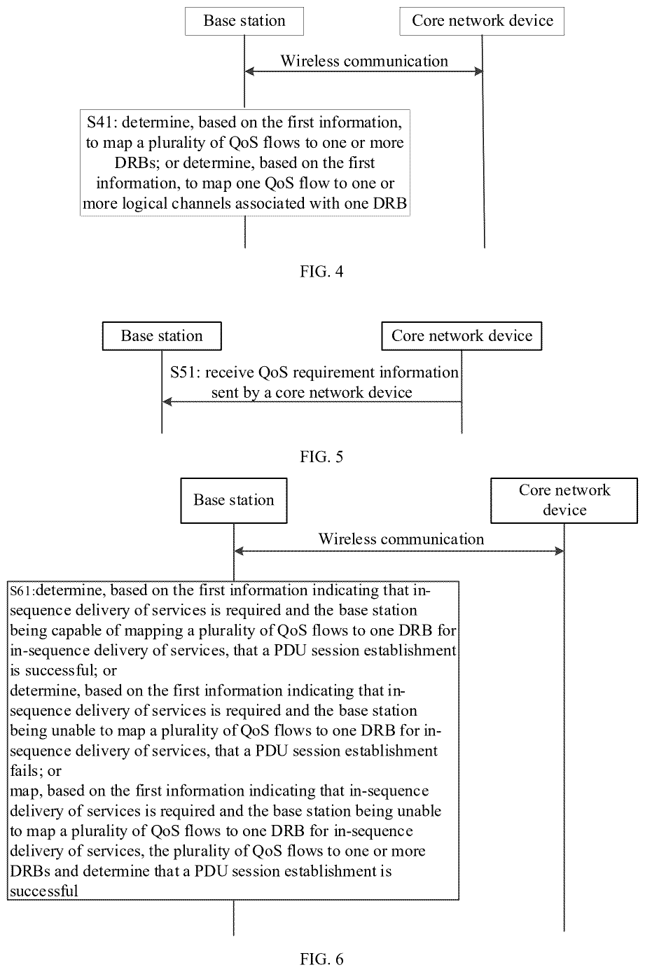

As shown in FIG. 5, an embodiment of the present disclosure provides a QoS management method, which is performed by a base station and includes the following step.

Step S51: receiving QoS requirement information sent by a core network device.

In the embodiments of the present disclosure, the QoS requirement information may be the QoS requirement information in the above embodiments. For example, the QoS requirement information includes but not limited to at least one of: a PDU set importance level; or a QoS parameter set according to the PDU set importance level. Here, the QoS parameter includes but is not limited to at least one of: a PDU set error rate (PSER), a PDU set delay budget (PSDB), or a PDU set integrated indication (PSII).

An embodiment of the present disclosure provides a QoS management method, which is performed by a base station and includes: determining, based on the PDU set importance level, to map one QoS flow to one or more logical channels associated with one DRB; or, determining, based on the QoS parameter, to map one QoS flow to one or more logical channels associated with one DRB.

In some embodiments, in step S31, determining QoS management based on first information includes one of:
determining, based on the PDU set importance level, to map one QoS flow to one or more logical channels associated with one DRB;
determining, based on the QoS parameter, to map one QoS flow to one or more logical channels associated with one DRB;
determining, according to the core network policy indicating that differentiated handling for a QoS flow is required and based on the PDU set importance level, to map one QoS flow to one or more logical channels associated with one DRB; or
determining, according to the core network policy indicating that differentiated handling for a QoS flow is required and based on the QoS parameter, to map one QoS flow to one or more logical channels associated with one DRB.

An embodiment of the present disclosure provides a QoS management method, which is performed by the base station and includes one of:
determining, based on a PDU set importance level, to map one QoS flow to one or more logical channels associated with one DRB;
determining, based on a QoS parameter, to map one QoS flow to one or more logical channels associated with one DRB;
determining, according to a core network policy indicating that differentiated handling for a QoS flow is required and based on a PDU set importance level, to map one QoS flow to one or more logical channels associated with one DRB; or
determining, according to a core network policy indicating that differentiated handling for a QoS flow is required and based on a QoS parameter, to map one QoS flow to one or more logical channels associated with one DRB.

In some embodiments, the determining, based on the PDU set importance level, to map one QoS flow to one or more logical channels associated with one DRB, including one of:
mapping PDU sets corresponding to different PDU set importance levels within a QoS flow to one logical channel associated with one DRB; or
mapping PDU sets corresponding to different PDU set importance levels within the QoS flow to different logical channels associated with one DRB.

In some embodiments, the determining QoS management based on first information includes one of:
mapping PDU sets corresponding to different PDU set importance levels within a QoS flow to one logical channel associated with one data radio bearer (DRB); or
mapping PDU sets corresponding to different PDU set importance levels within a QoS flow to identical one or different multiple logical channels associated with one DRB.

An embodiment of the present disclosure provides a QoS management method, which is performed by a base station and includes one of:
mapping PDU sets corresponding to different PDU set importance levels within a QoS flow to one logical channel associated with one data radio bearer (DRB); or
mapping PDU sets corresponding to different PDU set importance levels within a QoS flow to identical one or different multiple logical channels associated with one DRB.

For example, a QoS flow includes a plurality of PDU sets, and a PDU set corresponds to a PDU set importance level. The base station determines, according to the core network policy, that differentiated handling for data packets and/or data packet sets within one QoS flow is required, and determines to map PDU sets corresponding to a plurality of PDU set importance levels within the one QoS flow to one logical channel of one DRB. Or, the base station determines, according to the core network policy, that differentiated handling for data packets and/or data packet sets within one QoS flow is not required, and determines to map PDU sets corresponding to each PDU set importance level within the one QoS flow to one logical channel of one DRB, i.e., different PDU set importance levels can be mapped to the same or different logical channels associated with one DRB. Here, a data packet is a PDU, and a data packet set is a PDU set, and a PDU set includes at least one PDU.

For example, as shown in Table 1 below, a correspondence between PDU set importance level and a set of QoS parameter settings is provided:

TABLE 1

| | | |
|---|---|---|
| PDU set importance | PSER | For example, 5% |
| level is: level 0 | PSDB | For example, 10 ms |
| | PSII | For example, 1 |

In this way, in the embodiment of the present disclosure, one QoS flow can be accurately determined to be mapped to one logical channel or a plurality of logical channels associated with one DRB according to the PDU set importance level. In this way, the split transmission of PDU sets can be realized according to the importance of PDU sets.

In some embodiments, the determining, based on the QoS parameter, to map one QoS flow to one or more logical channels associated with one DRB includes: determining a PDU set importance level of a PDU set based on the QoS parameter of the PDU set, and determining, based on at least one PDU set importance level, to map the one QoS flow to the one or more logical channels associated with the one DRB.

In this way, the PDU set importance level of the PDU set can be determined according to QoS parameters of the PDU set, so that the QoS management mode can be determined according to the PDU set importance level (i.e., mapping a QoS flow to one or more logical channels of a DRB). In this way, the QoS management mode can be accurately determined according to the QoS parameters.

In other embodiments, the determining, based on the QoS parameter, to map one QoS flow to one or more logical channels associated with one DRB includes one of:
mapping PDU sets corresponding to different QoS parameters within the one QoS flow to one logical channel associated with the one DRB; or
mapping PDU sets corresponding to different QoS parameters within the one QoS flow to same or different logical channels associated with the one DRB.

An embodiment of the present disclosure provides a QoS management method, which is performed by a base station and includes one of:
mapping PDU sets corresponding to different QoS parameters within one QoS flow to one logical channel associated with one DRB; or
mapping PDU sets corresponding to different QoS parameters within one QoS flow to same or different logical channels associated with one DRB.

Here, a set of QoS parameters includes but is not limited to at least one of PSER, PSDB and PSII. A set of QoS parameters is set for a single PDU set importance level, i.e., different sets of QoS parameters can be set for different PDU set importance levels. For example, during scheduling, some PDU set importance level are relatively important data packet sets (i.e., PDU sets), then the packet loss rate of the packet sets may be relatively small, and the packet sets may be mapped to logical channels of a DRB with relatively high priorities.

In this way, the embodiment of the present disclosure can also accurately determine the QoS management mode according to the QoS parameters.

An embodiment of the present disclosure provides a QoS management method, which is performed by a base station and includes: determining, based on QoS parameters of a PDU set, a configuration of a logical channel to which the PDU set is mapped. The configuration may be, but is not limited to, a priority of the logical channel and/or the number of retransmissions of the logical channel. In this way, the configuration of the logical channel to which a PDU set is mapped can be achieved.

It should be noted that those skilled in the art can understand that the methods provided by the embodiments of the present disclosure can be executed alone or together with some methods in the embodiments of the present disclosure or some methods in related technologies.

An embodiment of the present disclosure provides a QoS management method, which is performed by a base station and includes: determining whether a PDU session is successfully established. Here, the determining whether the PDU session is successfully established includes: determining that a PDU session establishment is successful, or determining that a PDU session establishment fails. For example, if the base station determines that in-sequence delivery of services is required and a plurality of QoS flows have not been mapped to one DRB for in-sequence delivery of services, it determines that the PDU session establishment is successful. Or, if the base station determines that in-sequence delivery of services is required and a plurality of QoS flows have been mapped to one DRB for in-sequence delivery of services, it determines that the PDU session establishment fails.

As shown in FIG. 6, an embodiment of the present disclosure provides a QoS management method, which is performed by a base station and includes the following step.

Step S61: determining, based on the first information indicating that in-sequence delivery of services is required and the base station being capable of mapping a plurality of QoS flows to one DRB for in-sequence delivery of services, that a PDU session establishment is successful; or determining, based on the first information indicating that in-sequence delivery of services is required and the base station being unable to map a plurality of QoS flows to one DRB for in-sequence delivery of services, that a PDU session establishment fails; or mapping, based on the first information indicating that in-sequence delivery of services is required and the base station being unable to map a plurality of QoS flows to one DRB for in-sequence delivery of services, the plurality of QoS flows to one or more DRBs and determining that a PDU session establishment is successful.

An embodiment of the present disclosure provides a QoS management method, which is performed by a base station and includes: determining that a PDU session establishment is successful based on the core network policy indicating that in-sequence delivery of services is required and the base station being capable of mapping a plurality of QoS flows to one DRB for in-sequence delivery of services; or determining that a PDU session establishment fails based on the core network policy indicating that in-sequence delivery of services is required and the base station being unable to map a plurality of QoS flows to one DRB for in-sequence delivery of services; or mapping a plurality of QoS flows to one or more DRBs and determining that a PDU session establishment is successful based on the core network policy indicating that in-sequence delivery of services is required and the base station being unable to map the plurality of QoS flows to one DRB for in-sequence delivery of services.

In some embodiments of the present disclosure, the core network policy is the core network policy of any of the above embodiments, and the QoS flow is the QoS flow in the above embodiments.

For example, if the base station determines, based on the core network policy, that in-sequence delivery of services by an AS is required and maps a plurality of QoS flows to one DRB for in-sequence delivery, it determines that the PDU session establishment is successful. Or, if the base station determines, based on the core network policy, that in-sequence delivery of services by an AS is required and is unable to map a plurality of QoS flows to one DRB for in-sequence delivery of services, it determines that the PDU session establishment fails. Here, if the core network device determines that the base station must perform in-sequence delivery by the AS, the base station must perform in-sequence delivery by the AS; otherwise, it is determined that the PDU session establishment fails.

For example, if the base station determines, based on the core network policy, that in-sequence delivery by the AS is required but the base station is unable to map a plurality of QoS flows to one DRB for in-sequence delivery, it maps the plurality of QoS flows to one or more DRBs based on relevant technologies and determines that the PDU session establishment is successful. Here, if the core network device determines that the base station should strive to perform in-sequence delivery of services by the AS, the base station shall strive to perform in-sequence delivery of services by the AS; otherwise, it determines that the PDU session establishment fails.

An embodiment of the present disclosure provides a QoS management method, which is performed by a base station and includes: sending first response information to the core network device. Here, the response information includes but is not limited to first response information and/or second response information.

An embodiment of the present disclosure provides a QoS management method, which is performed by a base station and includes: sending first response information to a core network device, where the first response information includes at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

Here, the third indication information takes a first value to indicate that a plurality of QoS flows can be mapped to one DRB for in-sequence delivery of services, or a second value to indicate that the base station cannot map a plurality of QoS flows to one DRB for in-sequence delivery of services.

In this way, in the embodiment of the present disclosure, the core network device can be informed of a message and/or a reason why the base station is unable to map a plurality of QoS flows to one DRB for in-sequence delivery.

It should be noted that those skilled in the art can understand that the methods provided by the embodiments of the present disclosure can be executed alone or together with some methods in the embodiments of the present disclosure or some methods in related technologies.

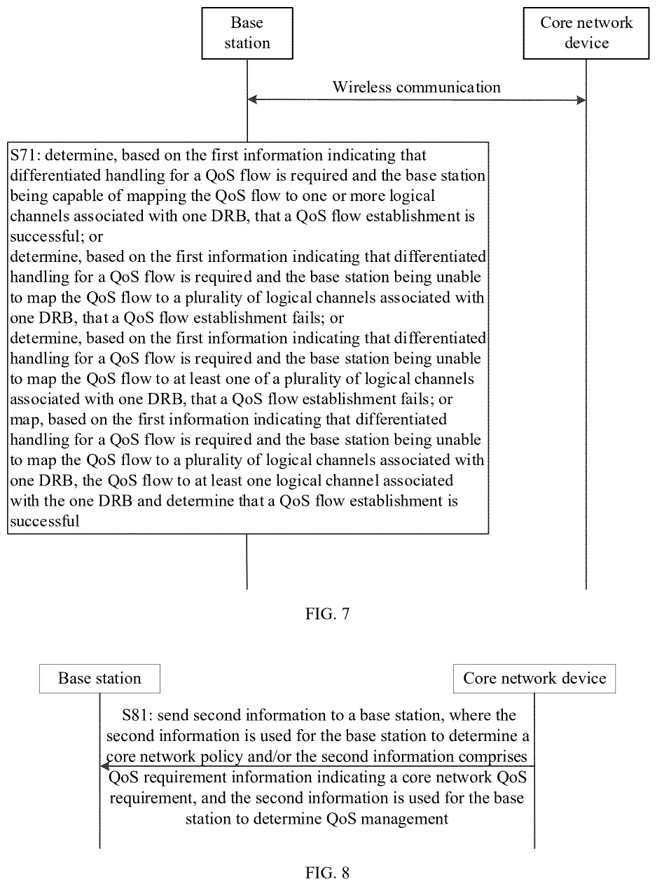

As shown in FIG. 7, an embodiment of the present disclosure provides a QoS management method, which is performed by a base station and includes the following step.

Step S71: determining, based on the first information indicating that differentiated handling for a QoS flow is required and the base station being capable of mapping the QoS flow to one or more logical channels associated with one DRB, that a QoS flow establishment is successful; or determining, based on the first information indicating that differentiated handling for a QoS flow is required and the base station being unable to map the QoS flow to a plurality of logical channels associated with one DRB, that a QoS flow establishment fails; or determining, based on the first information indicating that differentiated handling for a QoS flow is required and the base station being unable to map the QoS flow to at least one of a plurality of logical channels associated with one DRB, that a QoS flow establishment fails; or mapping, based on the first information indicating that differentiated handling for a QoS flow is required and the base station being unable to map the QoS flow to a plurality of logical channels associated with one DRB, the QoS flow to at least one logical channel associated with the one DRB and determining that a QoS flow establishment is successful.

An embodiment of the present disclosure provides a QoS management method, which is performed by a base station and includes: determining that a QoS flow establishment is successful based on the core network policy indicating that differentiated handling for a QoS flow is required and the base station being capable of mapping one QoS flow to one or more logical channels associated with associated with one DRB; or determining that a QoS flow establishment fails based on the core network policy indicating that differentiated handling for a QoS flow is required and the base station being unable to map one QoS flow to a plurality of logical channels associated with one DRB; or determining that a QoS flow establishment fails based on the core network policy indicating that differentiated handling for a QoS flow is required and the base station being unable to map the QoS flow to at least one of a plurality of logical channels associated with one DRB; or mapping the QoS flow to at least one logical channel associated with one DRB and determining that a QoS flow establishment is successful based on the core network policy indicating that differentiated handling for a QoS flow is required and the base station being unable to map a QoS flow to a plurality of logical channels associated with one DRB.

Here, the core network policy indicates that differentiated handling for the QoS flow is required and base station is unable to map one QoS flow to a plurality of logical channels associated with one DRB, the base station may map the QoS flow to at least one logical channel associated with the one DRB and determine that the QoS flow establishment is successful. For example, if it is assumed that a QoS flow needs to be mapped to three logical channels associated with a DRB but cannot be mapped to all three, the base station may map the QoS flow to one or two of the three logical channels and still determine that the QoS flow establishment is successful.

For example, the base station determines, based on the core network policy, that differentiated handling for a QoS flow is required, and the base station is capable of mapping one QoS flow to logical channels associated with one DRB for differentiated handling, then it determines that the QoS flow establishment is successful. Or, the base station determines, based on the core network policy, that differentiated handling for a QoS flow is required, but is unable to map one QoS flow to at least one of a plurality of logical channels associated with one DRB for differentiated handling, then it determines that the QoS flow establishment fails. Here, if the core network device determines that the base station must perform differentiated handling for a QoS flow, the base station must perform differentiated handling for a QoS flow; otherwise, it determines that the QoS flow establishment fails.

For example, the base station determines, based on the core network policy, that differentiated handling for a QoS flow is required, but is unable to map one QoS flow to a plurality of logical channels of one DRB for differentiated handling, the base station may map the one QoS flow to one logical channel associated with the one DRB or to other logical channels other than the plurality of logical channels in the one DRB, and then determine that the QoS flow establishment is successful. Here, if the core network device determines that the base station should strive to perform differentiated handling for a QoS flow, the base station shall strive to perform differentiated handling for a QoS flow; otherwise, it determines that the QoS flow establishment fails.

An embodiment of the present disclosure provides a QoS management method, which is performed by a base station and includes: sending second response information to a core network device, where the second response information includes at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

Here, the fourth indication information may take a third value indicating that the base station is capable of performing differentiated handling for a QoS flow, or the fourth indication information may indicate that differentiated handling for a QoS flow cannot be performed.

Here, the reason why the base station is unable to map a QoS flow to a plurality of logical channels for differentiated handling may include, but is not limited to, an RLC entity reaching the maximum number of retransmissions and/or a DRB being associated with one logical channel.

In this way, in the embodiment of the present disclosure, the core network device can be informed of a message and/or a reason why the base station is unable to map a QoS flow to a plurality of logical channels of one DRB for in-sequence delivery.

It should be noted that those skilled in the art can understand that the methods provided by the embodiments of the present disclosure can be executed alone or together with some methods in the embodiments of the present disclosure or some methods in related technologies.

An embodiment of the present disclosure provides a QoS management method, which is performed by a first base station and includes: sending handover request information to a second base station, where the handover request information requests a handover from the first base station to the second base station, and the handover request information includes the first information.

An embodiment of the present disclosure provides a QoS management method, which is performed by a first base station and includes: sending handover request information to a second base station, where the handover request information includes the core network policy and/or the QoS parameter and/or the PDU set importance level.

In some embodiments of the present disclosure, the first information may be the first information mentioned in the above embodiments, and the core network policy, the QoS parameter, and the PDU set importance level are respectively the core network policy, the QoS parameter, and the PDU set importance level mentioned in the above embodiments.

In an embodiment, the first base station is a source base station and the second base station is a target base station.

An embodiment of the present disclosure provides a QoS management method, which is performed by a base station and includes: receiving handover response information sent by the second base station, where the handover response information at least includes at least one of:
information indicating that the second base station is unable to provide a plurality of logical channels associated with one DRB; or
a reason why the second base station is unable to map a QoS flow to a plurality of logical channels for differentiated handling.

The handover response information may also include, but is not limited to, a reason and/or information indicating why the base station is unable to map a plurality of QoS flows to one or more DRBs for in-sequence delivery of services, etc.

In this way, in the embodiments of the present disclosure, in the scenario of base station handover, the core network policy, etc., can also be transmitted from the source base station (i.e., the first base station) to the target base station (i.e., the second base station), which is beneficial for the second base station to determine the QoS management mode.

Moreover, when the target base station is unable to map a plurality of QoS flows to one DRB for in-sequence delivery of services or unable to perform differentiated handling for data packets and/or data packet sets within one QoS flow, it also notifies the source base station of the event and/or the reasons for the event.

It should be noted that those skilled in the art can understand that the methods provided by the embodiments of the present disclosure can be executed alone or together with some methods in the embodiments of the present disclosure or some methods in related technologies.

The QoS management method described below is performed by a core network device and is similar in description to the QoS management method performed by the base station mentioned above. For technical details not disclosed in the embodiment of the QoS management method performed by the core network device, please refer to the description of the example of the QoS management method example performed by the base station, and will not be described in detail here.

As shown in FIG. 8, an embodiment of the present disclosure provides a QoS management method, which is performed by a core network device and includes the following step.

Step S81: sending second information to a base station, where the second information is used for the base station to determine a core network policy and/or the second information includes QoS requirement information indicating a core network QoS requirement, and the second information is used for the base station to determine QoS management.

Here, the second information is used for a User Equipment (UE) to determine first information. In an embodiment, the second information may be QoS requirement information, which includes but is not limited to a PDU set importance level and/or a QoS parameter. In another embodiment, the second information may be a core network policy.

In some embodiments of the present disclosure, the first information is the first information mentioned in the above embodiments, and the core network policy, the PDU set importance level and the QoS parameters are respectively the core network policy, the PDU set importance level and the QoS parameters mentioned in the above embodiments.

For example, the first information includes the core network policy and/or QoS requirement information. The first information indicates at least one of: whether in-sequence delivery of services is required; or whether differentiated handling for a QoS flow is required.

For example, the second information includes QoS requirement information, where the QoS requirement information includes at least one of:
a PDU set importance level; or
a QoS parameter set according to the PDU set importance level, where the QoS parameter includes at least one of: a PDU set error rate (PSER), a PDU set delay budget (PSDB), or a PDU set integrated indication (PSII).

For example, the QoS requirement information is used for the base station to map one QoS flow to one or more logical channels associated with one DRB.

For example, the core network policy indicates any policy for mapping a plurality of QoS flows to one or more DRBs and/or any policy for indicating that one QoS flow is mapped to one or more logical channels associated with one DRB.

For example, the core network policy indicates whether in-sequence delivery of services is required. For example, the core network policy indicates whether in-sequence delivery of services by an Access Stratum (AS) is required. For another example, the core network policy indicates whether in-sequence delivery of services by an application layer is required. Here, whether in-sequence delivery of services is required includes: in-sequence delivery of services is required, or in-sequence delivery of services is not required.

For example, the core network policy indicates whether differentiated handling for a QoS flow is required. For example, the core network policy indicates that differentiated handling for a QoS flow by the AS is required. For example, the core network policy indicates that differentiated handling for data packets and/or data packets set of a QoS flow by the AS is required.

In some embodiments, the second information includes first indication information. Sending the second information to the base station in Step S81 includes one of:
sending a protocol data unit (PDU) session to the base station, where the PDU session carries the first indication information, and the first indication information indicates whether in-sequence delivery of services is required.

An embodiment of the present disclosure provides a QoS management method, which is performed by a core network device and includes: sending a protocol data unit (PDU) session to the base station, where the PDU session carries the first indication information, and the first indication information indicates whether in-sequence delivery of services is required.

In some embodiments of the present disclosure, the first indication information and the second indication information are respectively the first indication information and the second indication information in the above embodiments.

Here, the first indication information may be carried in a PDU session and sent to the base station. Of course, in other embodiments, the first indication information may not be carried in the PDU session and sent to the base station or may be carried in the core network policy.

In some embodiments, the second information includes second indication information. Sending the second information to the base station in step S81 includes:
sending a QoS flow to the base station, where the QoS flow carries second indication information, and the second indication information indicates whether differentiated handling for the QoS flow is required.

An embodiment of the present disclosure provides a QoS management method, which is performed by a core network device and includes: sending a QoS flow to the base station, where the QoS flow carries second indication information, and the second indication information indicates whether differentiated handling for the QoS flow is required.

Here, the second indication information may be carried in a QoS flow and sent to the base station. Of course, in other embodiments, the second indication information may not be carried in the PDU session and sent to the base station or may be carried in the core network policy.

An embodiment of the present disclosure provides a QoS management method, which is performed by a core network device and includes: receiving response information sent by the base station, where the response information includes first response information and/or second response information.

An embodiment of the present disclosure provides a QoS management method, which is performed by a core network device and includes: receiving first response information sent by the base station, where the first response information includes at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

An embodiment of the present disclosure provides a QoS management method, which is performed by a core network device and includes: receiving second response information sent by the base station, where the second response information includes at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

For the above implementation, please refer to the description on the base station side for details, and will not be described again here.

It should be noted that those skilled in the art can understand that the methods provided by the embodiments of the present disclosure can be executed alone or together with some methods in the embodiments of the present disclosure or some methods in related technologies.

For the above implementation, please refer to the description on the base station side for details, and will not be described again here.

It should be noted that those skilled in the art can understand that the methods provided by the embodiments of the present disclosure can be executed alone or together with some methods in the embodiments of the present disclosure or some methods in related technologies.

To further explain any embodiments of the present disclosure, a specific embodiment is provided below.

An embodiment of the present disclosure provides a QoS management method, which is performed by a communication device, the communication device includes a base station and a core network device, and the QoS management method includes the following steps.

Step S81: the base station determines QoS management based on a core network policy.

Here, the determining QoS management may include: determining a QoS management mode.

In an embodiment, the base station determines the QoS management based on QoS requirement information, where the QoS requirement information includes: a PDU set importance level and/or a QoS parameter.

Here, step S81 may include step S81A and step S81B.

Step S81A: the base station determines, based on the core network policy, to map a plurality of QoS flows to one or more DRBs.

Here, the core network policy indicates whether in-sequence delivery of services by an AS is required.

For example, the core network device sends a PDU session, where each PDU session carries first indication information indicating whether in-sequence delivery by the AS is required. For each PDU session, if the first indication information carried by the PDU session indicates that in-sequence delivery of services by the AS is required, the base station determines to map a plurality of QoS flows to one DRB. Or, if the first indication information indicates that in-sequence delivery of services by the AS is not required, the base station determines to map a plurality of QoS flows to one or more DRBs.

For example, the first indication information carried in the core network policy or PDU session is optional. If the first indication information is not carried in the core network strategy or PUD session, it is determined that in-sequence delivery of services by the AS is not required.

Step S81B: determining, based on the core network policy, to map one QoS flow to one or more logical channels associated with one DRB.

Here, the core network policy indicates whether differentiated handling for data packets and/or data packet sets within one QoS flow by the AS is required (differentiated handling refers to handling based on the importance of services, if differentiated handling is required, one QoS flow can be mapped to a plurality of logical channels associated with one DRB).

For example, the core network device sends a QoS flow, where each QoS flow carries second indication information indicating whether differentiated handling for data packets and/or data packet sets within the QoS flow by the AS is required. For each QoS flow, if the second indication information carried by the QoS flow indicates that differentiated handling for data packets and/or data packet sets within the QoS flow by the AS is required, the base station determines to map the QoS flow to a plurality of logical channels associated with one DRB. Or, if the second indication information carried by the PDU session indicates that differentiated handling for data packets and/or data packet sets within the QoS flow by the AS is not required, the base station determines to map the QoS flow to one logical channel associated with one DRB.

For example, the second indication information carried in the core network policy or QoS flow is optional. If the second indication information is not carried in the core network policy or QoS flow, it is determined that differentiated handling for data packets and/or data packet sets within one QoS flow by the AS is not required.

In an embodiment, Step S81 further includes Step S81C.

Step S81C: the base station receives QoS requirement information sent by the core network device. The QoS requirement information includes, but is not limited to, at least one of: a PDU set importance level or a QoS parameter, where the QoS parameter includes at least one of: a PDU set error rate (PSER), a PDU set delay budget (PSDB), or a PDU set integrated indication (PSII).

Here, a set of QoS parameters is set for a PDU set importance level.

In an embodiment, the base station maps different PDU set importance levels within a QoS flow to different logical channels of a DRB.

Step S82: the base station determines whether the PDU session has been successfully established or whether the QoS flow has been successfully established. Step S82 includes Step S82A or Step S82B.

Step S82A is for cases where in-sequence delivery or differentiated handling is mandatory.

For example, if the base station determines, based on the core network policy, that in-sequence delivery by the AS is required but the base station is unable to map a plurality of QoS flows to one DRB for in-sequence delivery, it determines that the QoS flow establishment fails.

For example, the base station determines, based on the core network policy, that differentiated handling for a QoS flow is required, but is unable to map one QoS flow to at least one of a plurality of logical channels associated with one DRB for differentiated handling, then it determines that the QoS flow establishment fails.

Step S82B is for cases where in-sequence delivery or differentiated handling is preferable but not mandatory.

For example, if the base station determines, based on the core network policy, that in-sequence delivery by the AS is required but the base station is unable to map a plurality of QoS flows to one DRB for in-sequence delivery, it maps the plurality of QoS flows to one DRB or a plurality of DRBs, and determines that the QoS flow establishment is successful.

For example, the base station determines, based on the core network policy, that differentiated handling for a QoS flow is required, but is unable to map one QoS flow to a plurality of logical channels of one DRB for differentiated handling, the base station maps the one QoS flow to at least one logical channel associated with the one DRB and determines that the QoS flow establishment is successful.

Step S83: If the base station determines that the PDU session establishment fails or QoS flow establishment fails, it sends response information to the core network device.

For example, the base station sends at least one of the following pieces of information to the core network device:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

In an embodiment, if the base station is a first base station, it includes Step S84: sending the core network policy and/or QoS requirement information to a second base station.

For example, the first base station (i.e., the source base station) sends a handover request message to the second base station (i.e., the target base station). The handover request information requests a handover from the first base station to the second base station, and the handover request information includes the core network policy and/or QoS requirement information. The second base station sends handover response information to the first base station, including but not limited to at least one of: information indicating that the second base station is unable to provide a plurality of logical channels associated with one DRB; or a reason why the second base station is unable to map a QoS flow to a plurality of logical channels for differentiated handling.

For the above implementation, please refer to the description on the base station side and/or the core network device side for details, and will not be described again here.

It should be noted that those skilled in the art can understand that the methods provided by the embodiments of the present disclosure can be executed alone or together with some methods in the embodiments of the present disclosure or some methods in related technologies.

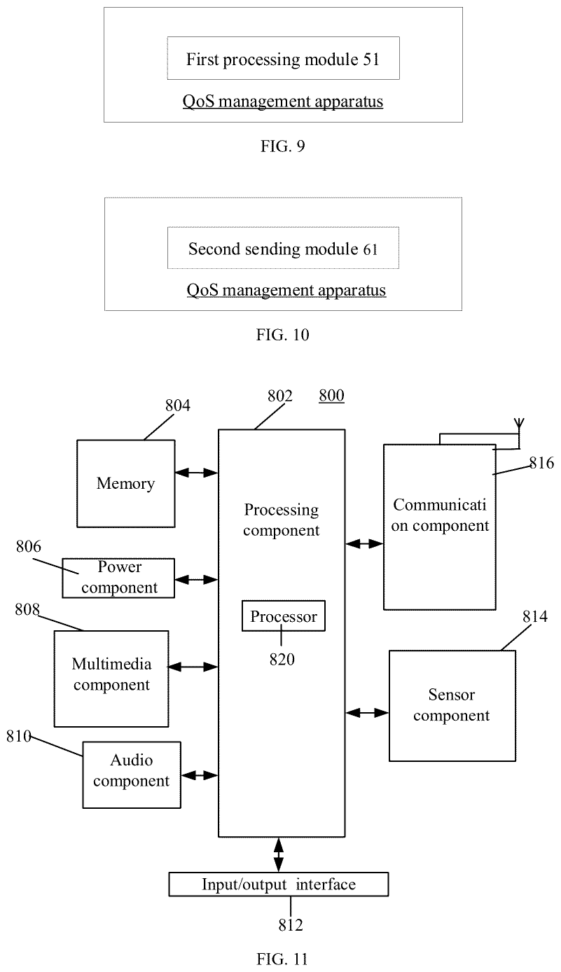

As shown in FIG. 9, an embodiment of the present disclosure provides a QoS management apparatus, including:
a first processing module 51, configured to determine QoS management based on first information, first information includes a core network policy and/or QoS requirement information indicating a core network QoS requirement.

The QoS management apparatus provided by the embodiment of the present disclosure may be a base station.

In some embodiments, the first information indicates at least one of:
whether in-sequence delivery of services is required; or
whether differentiated handling for a QoS flow is required.

An embodiment of the present disclosure provides a QoS management apparatus, which includes the first processing module 51 configured to determine, based on the first information, to map a plurality of QoS flows to one or more DRBs.

An embodiment of the present disclosure provides a QoS management apparatus, which includes the first processing module 51 configured to determine, based on the first information, to map one QoS flow to one or more logical channels associated with one DRB.

An embodiment of the present disclosure provides a QoS management apparatus, which includes the first processing module 51 configured to determine, based on the core network policy, to map a plurality of QoS flows to one or more DRBs.

An embodiment of the present disclosure provides a QoS management apparatus, which includes the first processing module 51 configured to determine, based on the core network policy, to map one QoS flow to one or more logical channels associated with one DRB.

An embodiment of the present disclosure provides a QoS management apparatus, which includes the first processing module 51 configured to map the plurality of QoS flows to one of the one or more DRBs based on the core network policy indicating that in-sequence delivery of services is required.

An embodiment of the present disclosure provides a QoS management apparatus, which includes the first processing module 51 configured to map the plurality of QoS flows to the one or more DRBs based on the core network policy indicating that in-sequence delivery of services is not required.

An embodiment of the present disclosure provides a QoS management apparatus, which includes a first receiving module configured to receive a protocol data unit (PDU) session sent by a core network device, where the PDU session carries first indication information, and the first indication information indicates whether in-sequence delivery of services is required.

An embodiment of the present disclosure provides a QoS management apparatus, which includes the first processing module 51 configured to determine, based on an absence of the first indication information in the PDU session, that in-sequence delivery of services is not required.

In some embodiments, the core network policy indicates whether differentiated handling for a QoS flow is required.

An embodiment of the present disclosure provides a QoS management apparatus, which includes the first processing module 51 configured to determine, based on the core network policy indicating that differentiated handling for data packets and/or data packets set within one QoS flow is required, to map the data packets and/or data packet sets within the one QoS flow to one or more logical channels associated with one DRB, where a data packet set includes one or more packets.

An embodiment of the present disclosure provides a QoS management apparatus, which includes the first processing module 51 configured to determine, based on the core network policy indicating that differentiated handling for data packets and/or data packet sets within one QoS flow is not required, to map the data packets and/or data packet sets within the one QoS flow to one logical channel associated with one DRB.

An embodiment of the present disclosure provides a QoS management apparatus, which includes the first receiving module configured to receive a QoS flow sent by a core network device, where the QoS flow carries second indication information, and the second indication information indicates whether differentiated handling for the QoS flow is required.

An embodiment of the present disclosure provides a QoS management apparatus, which includes the first processing module 51 configured to determine, based on an absence of the second indication information in the QoS flow, that differentiated handling for the QoS flow is not required.

An embodiment of the present disclosure provides a QoS management apparatus, which includes the first receiving module configured to receive QoS requirement information sent by a core network device, where the QoS requirement information includes at least one of:
a PDU set importance level; or
a QoS parameter set according to the PDU set importance level, where the QoS parameter includes at least one of: a PDU set error rate (PSER), a PDU set delay budget (PSDB), or a PDU set integrated indication (PSII).

An embodiment of the present disclosure provides a QoS management apparatus, which includes the first processing module 51 configured to perform one of:
determining, based on the PDU set importance level, to map one QoS flow to one or more logical channels associated with one DRB;
determining, based on the QoS parameter, to map one QoS flow to one or more logical channels associated with one DRB;
determining, according to the core network policy indicating that differentiated handling for a QoS flow is required and based on the PDU set importance level, to map one QoS flow to one or more logical channels associated with one DRB; or
determining, according to the core network policy indicating that differentiated handling for a QoS flow is required and based on the QoS parameter, to map one QoS flow to one or more logical channels associated with one DRB.

An embodiment of the present disclosure provides a QoS management apparatus, including:
the first processing module 51, configured to map PDU sets corresponding to different PDU set importance levels within a QoS flow to one logical channel associated with one data radio bearer (DRB); or
the first processing module 51, configured to map PDU sets corresponding to different PDU set importance levels within a QoS flow to identical one or different multiple logical channel(s) associated with one DRB.

An embodiment of the present disclosure provides a QoS management apparatus, which includes the first processing module 51 configured to perform one of:
determining, based on the first information indicating that in-sequence delivery of services is required and the base station being capable of mapping a plurality of QoS flows to one DRB for in-sequence delivery of services, that a PDU session establishment is successful;
determining, based on the first information indicating that in-sequence delivery of services is required and the base station being unable to map a plurality of QoS flows to one DRB for in-sequence delivery of services, that a PDU session establishment fails; or
mapping, based on the first information indicating that in-sequence delivery of services is required and the base station being unable to map a plurality of QoS flows to one DRB for in-sequence delivery of services, the plurality of QoS flows to one or more DRBs and determining that a PDU session establishment is successful.

An embodiment of the present disclosure provides a QoS management apparatus, which includes a first sending module configured to send first response information to a core network device, where the first response information includes at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

An embodiment of the present disclosure provides a QoS management apparatus, which includes the first processing module 51 configured to perform one of:
determining, based on the first information indicating that differentiated handling for a QoS flow is required and the base station being capable of mapping the QoS flow to one or more logical channels associated with one DRB, that a QoS flow establishment is successful;
determining, based on the first information indicating that differentiated handling for a QoS flow is required and the base station being unable to map the QoS flow to a plurality of logical channels associated with one DRB, that a QoS flow establishment fails;
determining, based on the first information indicating that differentiated handling for a QoS flow is required and the base station being unable to map the QoS flow to at least one of a plurality of logical channels associated with one DRB, that a QoS flow establishment fails; or

mapping, based on the first information indicating that differentiated handling for a QoS flow is required and the base station being unable to map the QoS flow to a plurality of logical channels associated with one DRB, the QoS flow to at least one logical channel associated with the one DRB and determining that a QoS flow establishment is successful.

An embodiment of the present disclosure provides a QoS management apparatus, which includes a first sending module configured to send second response information to a core network device, where the second response information includes at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

An embodiment of the present disclosure provides a QoS management apparatus, which is applied to a first base station and includes the first sending module configured to send handover request information to a second base station, where the handover request information requests a handover from the first base station to the second base station, and the handover request information includes the first information.

An embodiment of the present disclosure provides a QoS management apparatus, which is applied to a first base station and includes a first receiving module configured to receive handover response information sent by the second base station, where the handover response information at least includes at least one of:
information indicating that the second base station is unable to provide a plurality of logical channels associated with one DRB; or
a reason why the second base station is unable to map a QoS flow to a plurality of logical channels for differentiated handling.

As shown in FIG. 10, an embodiment of the present disclosure provides a QoS management apparatus, including:

a second sending module 61, configured to send second information to a base station, where the second information is used for the base station to determine a core network policy and/or the second information includes QoS requirement information indicating a core network QoS requirement, and the second information is used for the base station to determine QoS management.

The QoS management apparatus provided by the embodiment of the present disclosure may be a core network device.

In an embodiment, the second information is used for the base station to determine the first information, and the first information includes the core network policy and/or QoS requirement information.

In an embodiment, the first information indicates at least one of:
whether in-sequence delivery of services is required; or
whether differentiated handling for a QoS flow is required.

In some embodiments, the second information includes the first indication information.

An embodiment of the present disclosure provides a QoS management apparatus, which includes the second sending module 61 configured to send a protocol data unit (PDU) session to the base station, where the PDU session carries the first indication information, and the first indication information indicates whether in-sequence delivery of services is required.

In some embodiments, the second information includes second indication information.

An embodiment of the present disclosure provides a QoS management apparatus, which includes the second sending module 61 configured to send a QoS flow to the base station, where the QoS flow carries second indication information, and the second indication information indicates whether differentiated handling for the QoS flow is required.

In some embodiments, the second information includes QoS requirement information, where the QoS requirement information includes at least one of:
a PDU set importance level; or
a QoS parameter set according to the PDU set importance level, where the QoS parameter includes at least one of: a PDU set error rate (PSER), a PDU set delay budget (PSDB), or a PDU set integrated indication (PSII).

In some embodiments, the QoS requirement information is used for the base station to map one QoS flow to one or more logical channels associated with one DRB.

An embodiment of the present disclosure provides a QoS management apparatus, which includes a second receiving module, where the second receiving module is configured to receive first response information sent by the base station, where the first response information includes at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

An embodiment of the present disclosure provides a QoS management apparatus, which includes the second receiving module configured to receive second response information sent by the base station, where the second response information includes at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

It should be noted that those skilled in the art can understand that the apparatuses provided by the embodiments of the present disclosure can be executed alone or together with some apparatuses in the embodiments of the present disclosure or some apparatuses in related technologies.

Regarding to the apparatus in the above embodiment, a specific way in which each module performs operations has been described in detail in the embodiments relating to the method, and will not be described in detail here.

An embodiment of the present disclosure provides a communication device, including:
a processor; and
a memory, configured to store processor-executable instructions;
where the processor is configured to implement the QoS management method of any embodiment of the present disclosure when executing the executable instructions.

In an embodiment, the communication device may include, but is not limited to, at least one of a base station or a core network device.

The processor may include various types of storage media that are non-transitory computer storage media capable of continuing to memorize the information stored thereon after the user equipment is powered down.

The processor may be connected to the memory via a bus, etc., for reading an executable program stored on the memory, e.g., at least one of the methods as shown in FIGS. 3 to 8.

An embodiment of the present disclosure further provides a computer storage medium, where the computer storage medium stores a computer executable program, and the executable program, when executed by a processor, realizes the QoS management method of any embodiment of the present disclosure. For example, at least one of the methods shown in FIGS. 3 to 8.

Regarding to the apparatus or storage medium in the above embodiment, a specific way in which each module performs operations has been described in detail in the embodiments relating to the method, and will not be described in detail here.

FIG. 11 is a block diagram of a user equipment 800 according to an embodiment of the present disclosure. For example, the user equipment 800 may be a mobile phone, a computer, a digital broadcasting user equipment, a messaging device, a game console, a tablet device, a medical device, a fitness device, a personal digital assistant, etc.

Referring to FIG. 11, the user equipment 800 may include one or more of the following components: a handling component 802, a memory 804, a power component 806, a multimedia component 808, an audio component 810, an input/output (I/O) interface 812, a sensor component 814, and a communication component 816.

The handling component 802 generally controls an overall operation of the user equipment 800, such as operations associated with display, telephone call, data communication, camera operation and recording operation. The handling component 802 may include one or more processors 820 to execute instructions to complete all or part of steps of the above-mentioned method. In addition, the handling component 802 may include one or more modules to facilitate interactions between the handling component 802 and other components. For example, the handling component 802 may include a multimedia module to facilitate interactions between the multimedia component 808 and the handling component 802.

The memory 804 is configured to store various types of data to support operations in the user equipment 800. Examples of these data include instructions of any application program or method for being operated on the user equipment 800, contact data, phone book data, messages, pictures, videos, etc. The memory 804 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the user equipment 800. The power component 806 may include a power management system, one or more power supplies, and other components associated with generating, managing and distributing power for the user equipment 800.

The multimedia component 808 includes a screen that provides an output interface between the user equipment 800 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 808 includes a front camera and/or a rear camera. When the user equipment 800 is in an operation mode, such as a shooting mode or a video mode, the front camera and/or the rear camera can receive external multimedia data. Each front camera and rear camera may be a fixed optical lens system or have focal length and optical zoom capability.

The audio component 810 is configured to output and/or input audio signals. For example, the audio component 810 includes a microphone (MIC) configured to receive external audio signals when the user equipment 800 is in the operation mode, such as a calling mode, a recording mode and a voice recognition mode. The received audio signal may be further stored in the memory 804 or transmitted via the communication component 816. In some embodiments, the audio component 810 further includes a speaker for outputting audio signals.

The I/O interface 812 provides an interface between the handling component 802 and peripheral interface modules, where the peripheral interface modules may be keyboards, click-wheels, buttons, etc. These buttons may include, but are not limited to: home button, volume button, start button and lock button.

The sensor component 814 includes one or more sensors for providing various aspects of state evaluation for the user equipment 800. For example, the sensor component 814 can detect an on/off state of the user equipment 800, a relative positioning of components, for example, the components are the display and the keypad of the user equipment 800, and the sensor component 814 can also detect a position change of the user equipment 800 or a component of the user equipment 800, presence or absence of user contact with the user equipment 800 orientation or acceleration/deceleration of the user equipment 800 and a temperature change of the user equipment 800. The sensor component 814 may include a proximity sensor configured to detect presence of a nearby object without any physical contact. The sensor component 814 may also include an optical sensor, such as a CMOS or CCD image sensor, for use in imaging applications. In some embodiments, the sensor component 814 may further include an acceleration sensor, a gyroscope sensor, a magnetic sensor, a pressure sensor or a temperature sensor.

The communication component 816 is configured to facilitate wired or wireless communication between the user equipment 800 and other devices. The user equipment 800 can access a wireless network based on communication standards, such as WiFi, 4G or 5G, or combinations thereof. In an embodiment of the present disclosure, the communication component 816 receives a broadcast signal or broadcast related information from an external broadcast management system via a broadcast channel. In an embodiment of the present disclosure, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the user equipment 800 may be implemented by one or more application-specific integrated circuits (ASIC), digital signal processors (DSP), digital signal handling devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 804 including instructions, where the instructions can be executed by a processor 820 of the user equipment 800 to complete the above-mentioned method. For example, the non-transitory computer-readable storage medium may be an ROM, a random access memory (RAM), a CD-ROM, a magnetic tape, a floppy disk, an optical data storage device, etc.

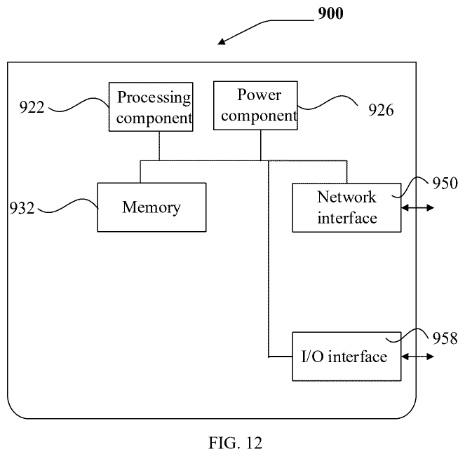

As shown in FIG. 12, an embodiment of the present disclosure shows a structure of a base station. For example, the base station 900 can be provided as a network-side device. Referring to FIG. 12, the base station 900 includes a handling component 922, which further includes one or more processors, and memory resources represented by a memory 932 for storing instructions that can be executed by the handling component 922, such as application programs. An application program stored in the memory 932 may include one or more modules each corresponding to a set of instructions. In addition, the handling component 922 is configured to execute instructions to perform any of the aforementioned methods applied to the base station.

The base station 900 may further include a power component 926 configured to perform power management of the base station 900, a wired or wireless network interface 950 configured to connect the base station 900 to a network, and an input-output (I/O) interface 958. The base station 900 can operate based on an operating system stored in the memory 932, such as Windows Server™, Mac OS X™, Unix™, Linux™, FreeBSD™ or the like.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A quality of service (QoS) management method, performed by a base station and comprising:
determining QoS management based on first information, wherein the first information comprises a core network policy and/or QoS requirement information indicating a core network QoS requirement.

2. The method according to claim 1, wherein the first information indicates at least one of:
whether in-sequence delivery of services is required; or
whether differentiated handling for a QoS flow is required.

3. The method according to claim 2, wherein the determining QoS management based on first information comprises at least one of:
determining, based on the first information, to map a plurality of QoS flows to one or more data radio bearers (DRBs); or
determining, based on the first information, to map one QoS flow to one or more logical channels associated with one DRB.

4. The method according to claim 3, wherein the determining, based on the first information, to map a plurality of QoS flows to one or more DRBs comprises one of:
mapping the plurality of QoS flows to one of the one or more DRBs based on the core network policy indicating that in-sequence delivery of services is required; or
mapping the plurality of QoS flows to the one or more DRBs based on the core network policy indicating that in-sequence delivery of services is not required.

5. The method according to claim 4, further comprising:
receiving a protocol data unit (PDU) session sent by a core network device, wherein the PDU session carries first indication information, and the first indication information indicates whether in-sequence delivery of services is required; and
determining, based on an absence of the first indication information in the PDU session, that in-sequence delivery of services is not required.

6. (canceled)

7. The method according to claim 3, wherein the determining, based on the first information, to map one QoS flow to one or more logical channels associated with one DRB comprises at least one of:
determining, based on the core network policy indicating that differentiated handling for data packets and/or data packet sets within one QoS flow is required, to map the data packets and/or data packet sets within the one QoS flow to one or more logical channels associated with one DRB, wherein a data packet set comprises one or more data packets; or
determining, based on the core network policy indicating that differentiated handling for data packets and/or data packet sets within one QoS flow is not required, to map data packets and/or data packet sets within the one QoS flow to one logical channel associated with one DRB.

8. The method according to claim 7, further comprising:
receiving a QoS flow sent by a core network device, wherein the QoS flow carries second indication information, and the second indication information indicates whether differentiated handling for the QoS flow is required; and
determining, based on an absence of the second indication information in the QoS in flow, that differentiated handling for the QoS flow is not required.

9. (canceled)

10. The method according to claim 1, further comprising:
receiving QoS requirement information sent by a core network device, wherein the QoS requirement information comprises at least one of:
a PDU set importance level; or
a QoS parameter set according to the PDU set importance level, wherein the QoS parameter comprises at least one of: a PDU set error rate (PSER), a PDU set delay budget (PSDB), or a PDU set integrated indication (PSII).

11. The method according to claim 10, wherein the determining QoS management based on first information comprises one of:
mapping PDU sets corresponding to different PDU set importance levels within a QoS flow to one logical channel associated with one data radio bearer (DRB); or
mapping PDU sets corresponding to different PDU set importance levels within a QoS flow to identical one or different multiple logical channels associated with one DRB.

12. The method according to claim 2, further comprising one of:
determining, based on the first information indicating that in-sequence delivery of services is required and the base station being capable of mapping a plurality of QoS flows to one DRB for in-sequence delivery of services, that a PDU session establishment is successful;
determining, based on the first information indicating that in-sequence delivery of services is required and the base station being unable to map a plurality of QoS flows to one DRB for in-sequence delivery of services, that a PDU session establishment fails; or
mapping, based on the first information indicating that in-sequence delivery of services is required and the base station being unable to map a plurality of QoS flows to one DRB for in-sequence delivery of services, the plurality of QoS flows to one or more DRBs and determining that a PDU session establishment is successful.

13. The method according to claim 12, further comprising:
sending first response information to a core network device, wherein the first response information comprises at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

14. The method according to claim 7, further comprising one of:
determining, based on the first information indicating that differentiated handling for a QoS flow is required and the base station being capable of mapping the QoS flow to one or more logical channels associated with one DRB, that a QoS flow establishment is successful;
determining, based on the first information indicating that differentiated handling for a QoS flow is required and the base station being unable to map the QoS flow to a plurality of logical channels associated with one DRB, that a QoS flow establishment fails;
determining, based on the first information indicating that differentiated handling for a QoS flow is required and the base station being unable to map the QoS flow to at least one of a plurality of logical channels associated with one DRB, that a QoS flow establishment fails; or
mapping, based on the first information indicating that differentiated handling for a QoS flow is required and the base station being unable to map the QoS flow to a plurality of logical channels associated with one DRB, the QoS flow to at least one logical channel associated with the one DRB and determining that a QoS flow establishment is successful.

15. The method according to claim 14, further comprising:
sending second response information to a core network device, wherein the second response information comprises at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

16. The method according to claim 1, wherein the base station is a first base station, and the method further comprises:
sending handover request information to a second base station, wherein the handover request information requests a handover from the first base station to the second base station, and the handover request information comprises the first information; and
receiving handover response information sent by the second base station, wherein the handover response information comprises at least one of:
information indicating that the second base station is unable to provide a plurality of logical channels associated with one DRB; or
a reason why the second base station is unable to map a QoS flow to a plurality of logical channels for differentiated handling.

17. (canceled)

18. A quality of service (QoS) management method, performed by a core network device and comprising:
sending second information to a base station, wherein the second information is used for the base station to determine a core network policy and/or the second information comprises QoS requirement information indicating a core network QoS requirement, and the second information is used for the base station to determine QoS management.

19. The method according to claim 18, wherein the second information comprises first indication information, and the sending second information to a base station comprises:
sending a protocol data unit (PDU) session to the base station, wherein the PDU session carries the first indication information, and the first indication information indicates whether in-sequence delivery of services is required; or
wherein the second information comprises second indication information; and the sending second information to a base station comprises:
sending a QoS flow to the base station, wherein the QoS flow carries second indication information, and the second indication information indicates whether differentiated handling for the QoS flow is required.

20. (canceled)

21. The method according to claim 19, wherein the second information comprises the second indication information and the QoS requirement information, and the QoS requirement information comprises at least one of:
a PDU set importance level; or
a QoS parameter set according to the PDU set importance level, wherein the QoS parameter comprises at least one of: a PDU set error rate (PSER), a PDU set delay budget (PSDB), or a PDU set integrated indication (PSII);
wherein the QoS requirement information is used for the base station to map one QoS flow to one or more logical channels associated with one DRB.

22. (canceled)

23. The method according to claim 18, further comprising:
receiving first response information sent by the base station, wherein the first response information comprises at least one of:
third indication information indicating that the base station is unable to map a plurality of QoS flows to one DRB for in-sequence delivery of services; or
a reason why the base station is unable to map a plurality of QoS flows to one DRB for in-sequence delivery of services.

24. The method according to claim 18, further comprising:
receiving second response information sent by the base station, wherein the second response information comprises at least one of:
fourth indication information indicating that the base station is unable to perform differentiated handling on a QoS flow;
information indicating that a plurality of logical channels associated with one DRB is unavailable; or
a reason why the base station is unable to map a QoS flow to a plurality of logical channels for differentiated handling.

25. (canceled)

26. (canceled)

27. A communication device, comprising:
a processor; and
a memory, configured to store processor-executable instructions;
wherein the processor is configured to;
determine quality of service (QoS) management based on first information, wherein the first information comprises at least one of a core network policy or QoS requirement information indicating a core network QoS requirement.

28. (canceled)
